(19) United States
(12) Patent Application Publication
(10) Pub. No.: US 2005/0023950 A1
(43) Pub. Date: Feb. 3, 2005

(54) Composition for forming an electron emission source for a flat panel display device and the electron emission source fabricated therefrom

(76) Inventors: Tae-Ill Yoon, Seoul (KR); Sung-Hee Cho, Seoul (KR); Sung-Kee Kang, Yongin-city (KR)

Correspondence Address: CHRISTIE, PARKER & HALE, LLP, PO BOX 7068, PASADENA, CA, 91109-7068, US

(21) Appl. No.: 10/746,879

(22) Filed: Dec. 24, 2003

(30) Foreign Application Priority Data
Jul. 31, 2003 (KR) 2003-0053064

(51) Int. Cl. H01J 1/30; H01J 9/02

(52) U.S. Cl. 313/311; 313/309

(57) ABSTRACT

Disclosed is a composition for forming an electron emission source of a flat panel display device, and the electron emission source fabricated from the same. The composition includes one or more carbon series materials for electron emission with a purity of at least 95%, glass frit, a binder resin, and a solvent. The electron emission source fabricated from the composition for forming the electron emission source of the present invention has high electron emission efficiency.

### CROSS REFERENCE TO RELATED APPLICATIONS

This application claims priority of Application No. 2003-53064, filed in the Korean Intellectual Property Office on Jul. 31, 2003, the disclosure of which is incorporated hereinto by reference.

### FIELD OF THE INVENTION

The present invention relates to a composition for forming an electron emission source for a flat panel display device, and an electron emission source fabricated using the same. More particularly, the present invention relates to a composition for forming an electron emission source with superior electron emission efficiency, and an electron emission source made from this composition.

### BACKGROUND

Early field emission display (FED) devices of flat panel displays used Spindt emitters that made an end sharp by laminating materials such as molybdenum, silicon, etc. However, as the Spindt electron emission source is a hyperfine structure, its production method is complicated and it requires a fabrication technology with a high degree of precision. As a result, there are limitations in the fabrication of enlarged field emission display devices.

Because of the above, research in which carbon series materials with low work functions are used as the electron emission source have recently been actively undertaken. Given that a carbon nano tube (CNT) with a particularly high aspect ratio among the carbon series materials has an extremely minute tip radius of about 100 Å, it is expected to be an ideal electron emission source for generating electrons smoothly even under an external voltage of 1-3V/μm.

After carbon series materials such as carbon nano tubes are generally prepared with solvents, binder resins, etc. in the form of paste, they are screen-printed between substrates and then formed to be electron emission sources through heat treatment processes. Because carbon nano tubes can be driven at a low voltage due to their low work function property, and because their fabrication is easy, they are more advantageous for realization of a large display.

However, if the electron emission source is formed from the carbon series materials by the screen printing method as described above, the carbon series materials are mixed with the paste and are irregularly distributed therein. Consequently, the ends of most of the carbon nano tubes are buried within the paste, and they need to be exposed to the outside. Japanese Patent Laid-open Publication No. 2000-223004 discloses a method to expose the nano tubes by mixing carbon and an elementary metal particle, compacting them, then selectively cutting and etching them. However, this method is somewhat complicated and difficult when applying it to an electron emission array in a field emission device.

Also, Japanese Patent Laid-open Publication No. 2000-36243 discloses a method to expose carbon nano tubes by selectively removing silver particles and binders on a printing pattern surface after irradiating a laser to the surface. However, the irradiation of the laser may cause thermal damage to the carbon nano tubes.

A carbon nano tube is made by using a difference in chemical potentials during a catalyzing phase between a catalytic metal (iron, cobalt, nickel, molybdenum, yttrium, etc.) and a carbon-based material from a raw carbon material flowed in through a pyrolysis process. A carbon nano tube is a material in which carbon has the shape of a tube or a cylinder, and the name ‘nano tube’ came from the fact that the tube generally has a diameter of around 1 nanometer. Nano tubes are classified as single-wall nano tubes, multi-wall nano tubes, and coiled nano tubes, according to their rolled shapes.

Synthesized carbon nano tube compositions contain a lot of catalytic metals and non-CNT materials. It is believed that the catalytic metals as electric conductors do not have any special effect on electron emission, and that the non-CNT materials function as a matrix that supports the carbon nano tubes and conveys electrons from a cathode to the carbon nano tubes. Therefore, it is thought to be desirable that the metals and the non-CNT materials of the carbon nano tube compositions are present in appropriate quantities, and methods of fabricating an electron emission source that add these materials as aiding materials have been suggested.

For example, Japanese Patent Laid-open Publication No. 2000-123712 discloses a cold cathode for field emission that is fabricated by mixing carbon materials for electron emission and carbon materials with electric conductivity such as graphite, carbon black, activated carbon, glass-based carbon, etc.

### SUMMARY OF THE INVENTION

The present invention has been made to address the problems stated above. One aspect of the present invention is a composition for forming an electron emission source for a flat panel display device with excellent electron emission efficiency. Another aspect of the present invention is an electron emission source fabricated from the composition for forming the electron emission source. Another aspect of the present invention is a flat panel display device including the electron emission source.

More particularly, the present invention provides a composition for forming an electron emission source for a flat panel display device containing a carbon series material for electron emission with purity of at least 95%, glass frit, a binder resin, and a solvent.

The present invention also provides an electron emission source made by printing a composition for forming the electron emission source on a substrate, and a flat panel display device including it.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, wherein:

FIG. 1a is a side cross-sectional view showing a cathode fabricated using the prior carbon nano tubes, and FIG. 1b is a side cross-sectional view showing a cathode fabricated using carbon nano tubes according to the present invention;

FIG. 2a is a Scanning Electron Microscope (SEM) photograph showing an electron emission source fabricated using the prior carbon nano tubes, and FIG. 2b is a Scanning Electron Microscope (SEM) photograph showing an electron emission source fabricated using carbon nano tubes according to the present invention;

FIGS. 3a and 3b are graphs showing results measured by a Thermogravimetric Analyzer (TGA) for carbon nano tubes before and after HNO₃ treatment, respectively.

FIG. 4 is a graph showing electron emission characteristics of the electron emission sources fabricated by Comparative Example 2, Comparative Example 3, Example 1, and Example 2.

### DETAILED DESCRIPTION OF THE PREFERRED EMBODIMENTS

The present invention is described in more detail below.

In the present invention, a composition for forming an electron emission source comprises a carbon series material for electron emission with a purity of at least 95%, glass frit, binder resin, and solvent.

Any carbon series material that has previously been applied as an electron emission source for a flat panel display device can be used. Examples of the carbon series material include carbon nano tubes (CNT), diamond, diamond-like carbon, graphite, and carbon black.

The carbon series material of the present invention has a purity of at least 95%, and preferably at least 98%. In other words, the carbon series material used as the electron emission source of the flat panel display device in the present invention contains non-emission impure materials comprising less than 5 wt % of the total weight. The non-emission impure materials include catalytic metals used in the syntheses of the carbon series materials, amorphous carbon, graphite (in the case the carbon series materials are other than graphite), etc. Catalytic metals for carbon nano tubes made by electric discharge of a carbon arc include Fe, Co, Ni, Mo, Y, etc.

All methods known in this field can be used for the method to cause the carbon series material to have purity of at least 95%. For example, the catalytic metals can be removed by dissolving them with acids such as HCl, HNO₃, etc., or by contact with an acidic gas. Moreover, other non-emission impure carbon-based materials besides the carbon series material used as the electron emission source can be eliminated by heat treatment at around 300 to 400° C., centrifugation, chromatography, etc.

The binder resin and the solvent used as elements of the composition for forming the electron emission source are called vehicle elements, and they assist easy printing of the composition. These vehicles are eliminated by complete volatilization through prescribed processes after printing the composition. The amount of the vehicle in the composition of the electron emission source can be appropriately controlled with respect to the amounts of the carbon series material and the glass frit used, and it is not especially limited.

An acryl-based resin, epoxy-based resin, a cellulose-based resin such as ethyl cellulose or nitrocellulose, or the like can be employed as the binder resin. As the solvent, organic solvents such as butyl carbitol acetate (BCA), terpineol (TP), texanol, or the like can be used.

Furthermore, the composition of the present invention can additionally include a photoreactive monomer, a photoinitiator, a photosensitive resin, and/or a non-photosensitive polymer as necessary.

The photoreactive monomer is added as an enhancer for decomposing a pattern, and it includes a thermal decomposable acrylate-based monomer, a benzophenon-based monomer, an acetophenone-based monomer, a thioxanthene-based monomer, or the like. More preferably, it includes epoxy acrylate, polyester acrylate, 2,4-diethyloxanthone, or 2,2-dimethoxy-2-phenyl acetophenone.

The composition for forming the electron emission source of the present invention is a paste preferably having a viscosity of 5,000 to 100,000 cps.

The electron emission source of the flat panel display device is fabricated to a desired shape by heat treatment after printing the paste composition for forming the electron emission source onto a substrate such as a metal, a semiconductor, an insulator, or the like. The heat treatment process can be executed under a vacuum atmosphere or a gas atmosphere. The gas atmosphere includes air, N₂ gas, or an inactivated gas. The printing process to form the electron emission source can be spin coating, screen printing, roll coating, or the like.

Hereinafter, the invention will be described in further detail by way of examples with reference to the accompanying drawings.

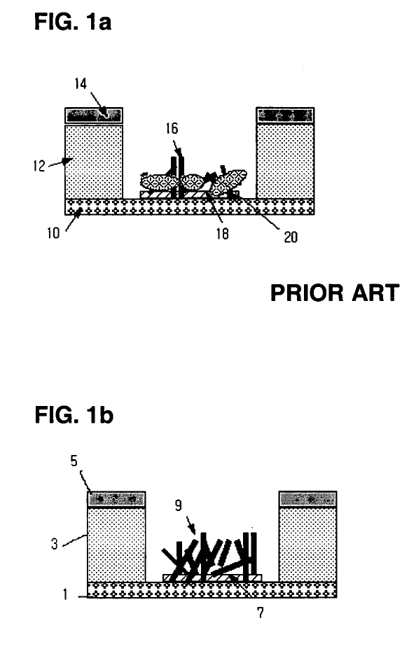

FIG. 1a is a side cross-sectional view showing an electron emission cathode fabricated using a paste composition including a carbon material, a binder resin, glass frit, and a solvent. The cathodes, which are fabricated by applying them to a field emission device structure composed of a cathode electrode 10, an insulator 12, and a gate electrode 14 as shown in FIG. 1a, are partially adhered to the glass frit 18 that is added for attachment of the carbon material 16. Most of the cathodes have structures that are attached to or covered by impurities 20 that remain after combustion of the resins added during the fabrication of the paste, or by the carbon materials that are partially added to impart them electric conductivity.

FIG. 1b is a side cross-sectional view showing a cathode fabricated by applying the composition for forming the electron emission source of the present invention to the field emission device structure composed of the cathode electrode 1, the insulator 3, and the gate electrode 5. As shown in FIG. 1b, the carbon material 9 for the electron emission source with high purity is attached to the glass frit 7, and impurities like the ones shown in FIG. 1a do not exist.

The electron emission source of the present invention is more advantageous in terms of electron emission due to a closed structure of its end.

The following examples and comparative examples illustrate the present invention in further detail. However, it is understood that the present invention is not limited by these examples.

### COMPARATIVE EXAMPLE 1

Unrefined powder of the carbon nano tubes and the glass frit were mixed in a ratio of 4:1 and ball-milled. A vehicle of dissolved ethyl cellulose resin in terpineol was mixed therein and stirred, producing a paste composition. An electron emission source as shown in FIG. 1a was fabricated by screen printing this paste composition.

### COMPARATIVE EXAMPLE 2

Non-CNT materials were removed by heating carbon nano tubes at around 350° C., followed by soaking them in HNO₃ for 1 hour to dissolve metal particles, to thereby obtain carbon nano tube powder with purity of 60%. Non-CNT materials included in the carbon nano tube powder made up less than 0.5 wt %, and the amount of catalytic metal was 40 wt %. An electron emission source as shown in FIG. 1a was fabricated through the same method as in Comparative Example 1 by using the purified carbon nano tube powder.

### COMPARATIVE EXAMPLE 3

An electron emission source was prepared by the same method as in Comparative Example 2, except that purified carbon nano tubes that were heated at around 350° C. and then soaked for 24 hours were used. Non-CNT materials included in the carbon nano tube powder made up less than 0.5 wt %, and the amount of catalytic metal was 20 wt %.

### EXAMPLE 1

An electron emission source was prepared by the same method as in Comparative Example 2, except that purified carbon nano tubes that were heated at around 350° C. and then soaked for 40 hours were used. Non-CNT materials included in the carbon nano tube powder made up less than 0.5 wt %, and the amount of catalytic metal was 5 wt %.

### EXAMPLE 2

An electron emission source was prepared by the same method as in Comparative Example 1, except that purified carbon nano tubes that were heated at around 350° C. and then soaked for 48 hours were used. Non-CNT materials included in the carbon nano tube powder made up less than 0.5 wt %, and the amount of catalytic metal was 2 wt %.

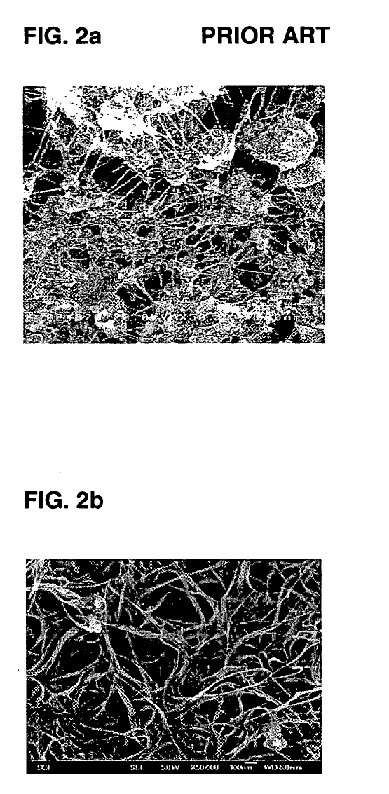

FIG. 2a and FIG. 2b are Scanning Electron Microscope (SEM) photographs of the electron emission sources fabricated according to Comparative Example 1 and Example 1, respectively. As shown in FIG. 2a, the electron emission source made according to Comparative Example 1 included a large quantity of impurities in addition to the carbon nano tubes. In comparison, FIG. 2b shows that impurities in the electron emission source made according to Example 1 were almost completely removed.

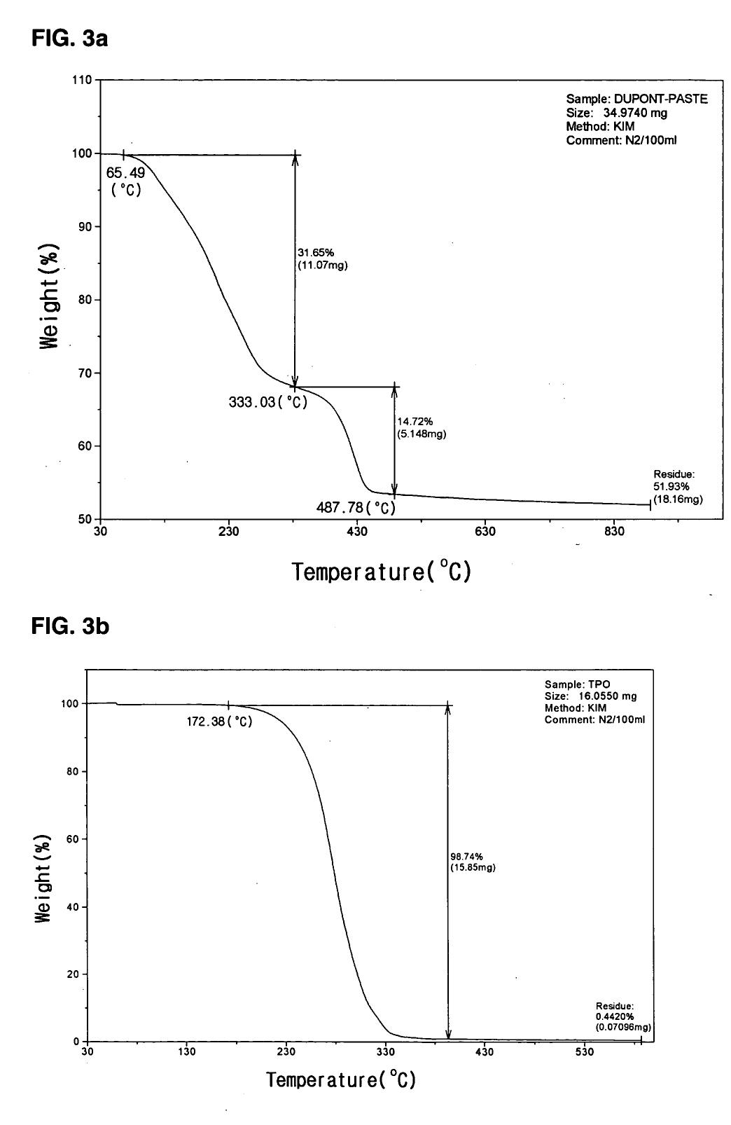

Residual amounts of the catalytic metals were measured by dividing the carbon nano tubes treated at about 350° C. into cases before and after HNO₃ treatment. FIG. 3a and FIG. 3b are graphs that illustrate results measured by a Thermogravimetric Analyzer (TGA), showing the amount of carbon nano tubes before and after HNO₃ treatment, respectively. In the case of HNO₃-untreated CNT, the residual amount of the catalytic metal was about 40 wt %, but an amount of less than 5 wt % remained in the case of CNT that was treated with HNO₃ for 40 hours.

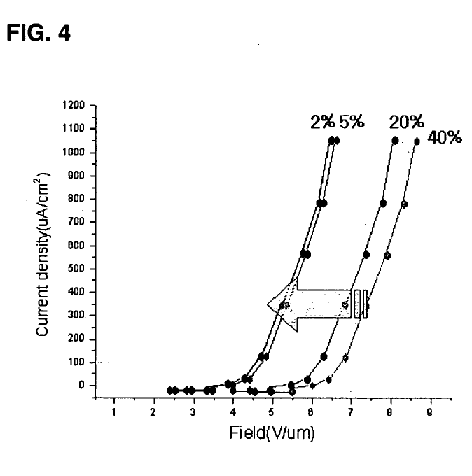

FIG. 4 is a graph showing estimations of electron emission characteristics of the electron emission sources fabricated according to Comparative Example 2, Comparative Example 3, Example 1, and Example 2. As shown in FIG. 4, the electron emission characteristics are remarkably improved as the amount of residual metal is reduced.

As the electron emission source for the flat panel display device of the present invention includes a carbon series material of high purity, its electron emission characteristic is positively distinguished.

While the present invention has been described in detail with reference to the preferred embodiments, those skilled in the art will appreciate that various modifications and substitutions can be made thereto without departing from the spirit and scope of the present invention as set forth in the appended claims.

1. A composition for forming an electron emission source of a flat panel display device, comprising one or more carbon series materials for electron emission with a total purity of at least 95%, glass frit, a binder resin, and a solvent.

2. The composition according to claim 1, wherein the one or more carbon series materials have a total purity of at least 98%.

3. The composition according to claim 1, wherein the one or more carbon series materials for electron emission are selected from the group consisting of carbon nano tubes, diamond, diamond-like carbon, graphite, and carbon black.

4. The composition according to claim 1, wherein the one or more carbon series materials include non-emission impure materials in an amount less than 5 wt. % based on the total weight of the materials.

5. The composition according to claim 4, wherein the non-emission impure materials are selected from the group consisting of catalytic metals, amorphous carbon, and graphite when the one or more carbon series materials are other than graphite.

6. The composition according to claim 4, further comprising at least one material selected from the group consisting of photoreactive monomers, photoinitiators, photosensitive resins, and non-photosensitive polymers.

7. A composition for forming an electron emission source of a flat panel display device, comprising carbon nano tubes for electron emission including one or more catalytic metals in an amount less than 5 wt. % and having a purity of at least 95%, glass frit, a binder resin, and a solvent.

8. The composition according to claim 7, wherein the carbon nano tubes for electron emission have a purity of at least 98%.

9. The composition according to claim 7, wherein the carbon nano tubes include a non-CNT material selected from the group consisting of catalytic metals, amorphous carbon, and graphite in an amount less than 5 wt. %.

10. The composition according to claim 7, further comprising at least one material selected from the group consisting of photoreactive monomers, photoinitiators, photosensitive resins, and non-photosensitive polymers.

11. An electron emission source fabricated by printing and coating the composition for forming the electron emission source according to claim 1.

12. The electron emission source according to claim 11, wherein said electron emission source has a closed end.

13. A flat panel display device including an electron emission source fabricated by printing and coating the composition for forming the electron emission source according to claim 7.

14. The flat panel display device according to claim 13, wherein said electron emission source has a closed end.

15. The flat panel display device according to claim 13, wherein said device is a field emission device.

16. A method for producing an electron emission source comprising printing and coating the composition according to claim 1.

17. A method for producing an electron emission source comprising printing and coating the composition according to claim 7.

18. A method for producing a flat panel display device comprising printing and coating the composition according to claim 1.

19. A method for producing a flat panel display device comprising printing and coating the composition according to claim 7.
